(19) United States
(12) Patent Application Publication
(10) Pub. No.: US 2026/0353082 A1
(43) Pub. Date: Nov. 5, 2026

(54) TUNNELED EAP-BASED SINGULAR ACCESS AND AUTHENTICATION TECHNIQUES

(71) Applicant: Cisco Technology, Inc., San Jose, CA (US)

(72) Inventors: Anuj Dharap, Copley, OH (US); Stephen Michael Orr, Wallkill, NY (US); Juan Carlos Zuniga, Montreal (CA); John Matthew Swartz, Lithia, FL (US); Binita Gupta, San Diego, CA (US); Brian D. Hart, Sunnyvale, CA (US)

(21) Appl. No.: 19/639,524

(22) Filed: Apr. 6, 2026

Related U.S. Application Data
(60) Provisional application No. 63/797,165, filed on Apr. 30, 2025.

(51) Int. Cl. H04W 12/069; H04W 12/0433

(52) U.S. Cl. CPC H04W 12/069; H04W 12/0433

(57) ABSTRACT

Techniques herein utilize Tunneled Extensible Authentication Protocol (TEAP) and security capability advertisements that can include authentication and key management (AKM) information and cipher suite information for a single service set identifier (SSID) to facilitate a singular, synchronized access and authentication mechanism for wireless networks (e.g., wireless local area networks) and wired networks.

### PRIORITY CLAIM

This application claims the benefit of priority under 35 U.S.C. § 119 to U.S. Provisional Application Serial No. 63/797,165, filed Apr. 30, 2025, the entirety of which is incorporated herein by reference.

### TECHNICAL FIELD

The present disclosure relates to wireless networks.

### BACKGROUND

In wireless and wired networks, multiple authentication and key management (AKM) options/protocols/combinations create compatibility issues. There is a need for a simplified common AKM that allows moving the negotiations up the stack, while still maintaining a baseline level of security over the wireless/wired medium. In a wireless local area network, there are privacy concerns due to both wireless clients and access points (APs) advertising exact capabilities of cipher suite support over the air in the open. There is a lack of cohesive security across the whole network, with wireless security not necessarily equivalent to wider network security. Furthermore, sometimes there is a need to deploy multiple service set identifiers (SSIDs) to support different configurations, which makes the deployment more complicated.

### BRIEF DESCRIPTION OF THE DRAWINGS

FIG. 1 illustrates a block diagram of a wireless network that includes multiple wireless local area network (WLAN) access points (APs) that are configured to advertise security profile information and facilitate tunneled Extensible Authentication Protocol (EAP) exchanges with one or more clients, according to an example embodiment.

FIGS. 2A and 2B illustrate example details for advertising security profile information by a WLAN AP, according to various example embodiments.

FIGS. 3A, 3B, and 3C are a flowchart depicting example operations through which a tunneled EAP exchange process can be performed between a client and an authentication server, according to various example embodiments.

FIG. 4 is a flowchart depicting a method according to an example embodiment.

FIG. 5 illustrates a hardware block diagram of a computing device configured to perform functions associated with operations discussed in connection with embodiments herein.

### DESCRIPTION OF EXAMPLE EMBODIMENTS

### Overview

Presented herein are techniques for tunneled Extensible Authentication Protocol (EAP) that can utilize new authentication and key management (AKM) protocol(s) (AKMP(s)) as a singular, synchronized access and authentication for wireless and wired networks.

In some aspects, the techniques described herein relate to a method including: receiving, by a wireless client device, one or more wireless frames from an access point (AP), the one or more wireless frames including information identifying one or more security profiles for a single service set identifier (SSID), wherein each security profile corresponds to an authentication and key management protocol (AKMP) of a plurality of AKMPs and at least one cipher suite; selecting, by the wireless client device, a first security profile of the one or more security profiles; establishing a security association including establishing a secure tunnel between the wireless client device and an authentication server using a tunneled authentication protocol, wherein the tunneled authentication protocol enables the wireless client device to indicate one or more cipher suites supported by the wireless client device, wherein each cipher suite of the one or more cipher suites corresponds to a security level of one or more security levels supported by the wireless client device; and exchanging with the authentication server, via the secure tunnel, credential information for authentication of the wireless client device and establishment of the security association based on a cipher suite corresponding to the first security profile.

In some aspects, the techniques described herein relate to a wireless client device including: at least one memory element for storing data; and at least one processor for executing instructions associated with the data, wherein executing the instructions causes the wireless client device to perform operations, including: receiving, by the wireless client device, one or more wireless frames from an access point (AP), the one or more wireless frames including information identifying one or more security profiles for a single service set identifier (SSID), wherein each security profile corresponds to an authentication and key management protocol (AKMP) of a plurality of AKMPs and at least one cipher suite; selecting, by the wireless client device, a first security profile of the one or more security profiles; establishing a security association including establishing a secure tunnel between the wireless client device and an authentication server using a tunneled authentication protocol, wherein the tunneled authentication protocol enables the wireless client device to indicate one or more cipher suites supported by the wireless client device, wherein each cipher suite of the one or more cipher suites corresponds to a security level of one or more security levels supported by the wireless client device; and exchanging with the authentication server, via the secure tunnel, credential information for authentication of the wireless client device and establishment of the security association based on a cipher suite corresponding to the first security profile.

In some aspects, the techniques described herein relate to a non-transitory computer readable storage medium including instructions that when executed configure one or more processors of a wireless client device to perform operations including: receiving, by the wireless client device, one or more wireless frames from an access point (AP), the one or more wireless frames including information identifying one or more security profiles for a single service set identifier (SSID), wherein each security profile corresponds to an authentication and key management protocol (AKMP) of a plurality of AKMPs and at least one cipher suite; selecting, by the wireless client device, a first security profile of the one or more security profiles; establishing a security association including establishing a secure tunnel between the wireless client device and an authentication server using a tunneled authentication protocol, wherein the tunneled authentication protocol enables the wireless client device to indicate one or more cipher suites supported by the wireless client device, wherein each cipher suite of the one or more cipher suites corresponds to a security level of one or more security levels supported by the wireless client device; and exchanging with the authentication server, via the secure tunnel, credential information for authentication of the wireless client device and establishment of the security association based on a cipher suite corresponding to the first security profile.

### Example Embodiments

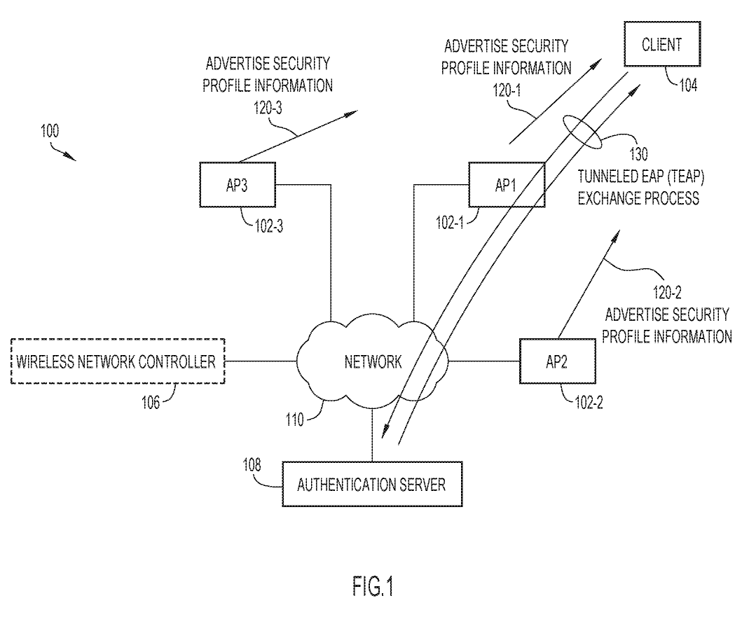

FIG. 1 is a block diagram of a system 100 that includes multiple wireless local area network (WLAN) access points (APs) that are configured to advertise security profile information and facilitate Tunneled Extensible Authentication Protocol (EAP) exchange processes with one or more clients or stations (STAs), according to an example embodiment. In at least one embodiment, the system 100 may include a WLAN that includes a plurality of access points (APs), for example, an AP1, an AP2, and an AP3 at reference numerals 102-1, 102-2, and 102-3, respectively, that serve wireless client devices or wireless stations (STAs), such as a client 104. In at least one embodiment, system 100 may also include a wireless network controller 106 that may be involved in the techniques herein. A wireless network controller, such as wireless network controller 106, can be referred to as a WLAN controller (WLC). In at least one embodiment, system 100 may further include an authentication element, such as an authentication server 108. In at least one embodiment, authentication server 108 may be implemented as an Authentication, Authorization, and Accounting (AAA) service or server. In at least one embodiment, system 100 may further include a network 110 that may be implemented as a wired network.

Each of AP1, AP2, and AP3 can interface with each other, wireless network controller 106, and authentication server 108 via network 110. In some instances, AP1, AP2, and AP3 can interface with each other wirelessly via one or more wireless connections.

Each of AP1, AP2, and AP3 includes any hardware and/or software to perform baseband signal processing (such as modulation/demodulation) as well as hardware (e.g., baseband processors (modems), transmitters, and receivers, transceivers, and/or the like), software, logic, and/or the like to facilitate signal transmissions and signal receptions via antenna assemblies (not shown) in order to connect with one or more clients.

A wireless client device or wireless STA, such as client 104, may be any electronic device, etc., that initiates a connection or communication session with a corresponding network, and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, a cellular/Wi-Fi® enabled device, and/or any other device, component, element, or object capable of performing wireless voice, audio, video, media, or data exchanges within a system. Thus, a wireless device may include any hardware and/or software to perform baseband signal processing (such as modulation/demodulation) as well as hardware (e.g., baseband processors (modems), transmitters and receivers, transceivers, and/or the like), software, logic, and/or the like to facilitate signal transmissions and signal receptions via antenna assemblies (not shown) in order to connect to one or more radio nodes of one or more radio access networks (RANs), such as any of AP1, AP2, and/or AP3.

In various embodiments, client 104 and AP1 102-1, AP2 102-2, and AP3 102-3 can support any combination of Institute of Electrical and Electronics Engineers (IEEE) 802.11 WLAN (Wi-Fi®) standards (e.g., Wi-Fi 6/6E®, Wi-Fi 7®, Wi-Fi 8®, etc.).

In at least one embodiment, wireless network controller 106 can facilitate management, control, etc., of each of AP1, AP2, and AP3. In at least one embodiment, authentication server 108 can facilitate authentication operations performed for a given client such that, upon successful authentication of the client, the client can be successfully connected with a given AP. Although shown as a standalone node in FIG. 1, in various embodiments, authentication server 108 can be implemented as an authenticator service configured for any combination of AP1, AP2, and/or AP3 and/or as an authenticator service configured for the wireless network controller 106. Broadly, authentication services/operations provided by authentication server 108 (as a standalone node, implemented via any AP(s), and/or via a wireless network controller) can be characterized as an authentication services plane or authentication plane that facilitates authenticator or authentication services for authenticating one or more client connections with APs.

Broadly, embodiments herein may facilitate techniques through which any of AP1, AP2, and AP3 can advertise security profile information, such as any combination of authentication and key management (AKM) options/protocols, also referred to herein as AKM protocols (AKMPs), and cipher suite information associated with each AKMP. For example, as shown in FIG. 1 at 120-1, AP1 102-1 can advertise security profile information for one or more security profiles supported by AP1 102-1 to a client device, such as client 104, via one or more wireless frames transmitted by AP1 102-1. Other APs, such as AP2 102-2 and AP3 102-3, can perform similar security profile information advertisements, as shown at 120-2 and 120-3, via one or more wireless frames transmitted by each of AP2 102-2 and AP3 102-3. The terms AKM and AKMP can be referred to herein interchangeably.

In various embodiments, security profile information advertisements performed by APs can include transmitting any combination of Beacon frames, Probe Response frames, Access Network Query Protocol (ANQP) frames, and/or the like via one or more wireless frames.

Instead of advertising multiple different service set identifiers (SSIDs) that are all the same except that each has a unique Robust Secure Network (RSN) (Robust Secure Network Element (RSNE), Robust Secure Network Extension element (RSNXe), MRSNO (a WPA3-Personal Compatibility mode), etc.), with their own AKMP and Cipher Suite (also, cipher suite herein) combinations, an AP device, such as AP1 102-1, can advertise (transmit), for a single SSID in place of the multiple SSIDs, security profile information for one or more security profiles supported by the AP device utilizing an AKM Only Approach, an AKM + Cipher Suite Approach, or a Bitmap/Lists Approach in accordance with embodiments herein. There might still be multiple SSIDs advertised for legacy reasons and/or because of other differences in Basic Service Set (BSS) parameters, yet, for each of the multiple SSIDs, more than one security profile can be advertised in accordance with embodiments herein.

In at least one embodiment, the AKMP(s) for security profile(s) being advertised (transmitted) can be unique, newly defined AKMP(s), whose purpose will be to indicate that a given SSID supports these new access and authentication mechanisms, via one or more of:
AKM Only Approach: In this approach, newly defined AKMP identifiers (also referred to herein as 'profile identifiers') on their own or security profile numbers can be advertised. Each newly defined AKMP identifier or security profile number in this approach can correspond to a combination of a method of access (e.g., Open, Opportunistic Wireless Encryption (OWE), Passphrase, IEEE 802.1x, Commercial National Security Algorithm (CNSA) 2.0, etc.) and a minimum level of cipher suite support (e.g., Secure Hash Algorithm (SHA)-x, where 'x' indicates an x-byte key, such as SHA-256, SHA-512, etc.) supported on that method of access.
AKM + Cipher Suite Approach: In this approach, each of a newly defined AKMP identifier would correspond to a method of access (Open, OWE, Passphrase, IEEE 802.1X, etc.) that can be advertised. Cipher Suites would still be advertised alongside the AKMP identifiers in another advertisement. A Cipher Suite Combination advertised can indicate the minimum level of security support (SHA-256, SHA-512, etc.) within the SSID supported on that network. The combination of an AKMP identifier obtained via an advertisement and Cipher Suite(s) obtained via another advertisement (or multiple other advertisements) can correspond to one or more security profiles. One or both of these may be the security profiles advertised using bitmaps, as discussed in further detail herein.
Bitmap/Lists Approach: In at least one embodiment for this approach, a bitmap with each bit corresponding to a security profile number can be advertised by a given AP. In at least one embodiment for this approach, for each AKMP advertised, a given AP can indicate different levels of security supported using a bitmap (and not just indicate the minimum level(s) and optionally maximum level(s) of security). A client can use this information to determine if an AP can provide an adequate level of security desired by the client. Other variations for the Bitmap/Lists Approach can be envisioned, as discussed herein.

Where ordering is non-obvious, an order of advertised security profile information can be defined in at least one embodiment. Whenever it may not be possible to achieve a (one-dimensional or simple) linear ordering, multiple orderings might be established (e.g., one for high capability devices, one for low capability devices such as Internet of Things (IoT) devices, etc.), and then multiple minima might be advertised, for example, one per enabled ordering.

In addition, maxima might be advertised as well, using the same techniques as noted above, defined linear ordering, if possible (with (optional) maximum), otherwise, multiple defined orderings (with potential for multiple optional maxima) can be advertised. This can help clients with stronger security expectations to determine a given security posture for connecting to a given AP.

In some instances, indicating only minimum and/or extremum (maximum) level(s) of security may not provide a client with enough visibility to make an informed decision for selecting an AP for connectivity. Hence, providing a bitmap of supported cipher suites can be desirable, as can be provided by the Bitmap/Lists Approach. In addition:
there might be multiple bitmaps as described above (e.g., one per enabled ordering); and
to keep the bitmap from growing indefinitely over time, a list of supported cipher suites might be expressed as a minimum supported cipher suite plus a bitmap for the higher cipher suites. That is, the meaning of individual bits can vary according to the minimum supported cipher suite. The bitmap might have a fixed length or a variable (extensible) length and, if so, can be preceded by a length field.

By obtaining security profile information advertisements from one or more APs, client 104 can make an informed decision for selecting an AP for connectivity. For example, the client 104 can select an AP for connectivity based on the AP supporting method(s) of access (AKMP(s)) and supporting security level(s) (cipher suite(s)) that are also supported and/or desirable by the client 104 for establishing a wireless connection with the AP. In one example, consider that client 104 selects AP1 102-1 for establishing a wireless connection based on security capabilities (security profile information) obtained by the client from AP1 102-1 through one or more security profile information advertisements (120-1).

In at least one embodiment, Tunneled EAP (TEAP) can be used as a transport to exchange security capabilities and agree on a common configuration through a Tunneled EAP (TEAP) exchange process, as generally shown in FIG. 1 at reference numeral 130, that can be performed between client 104 and the authentication server 108, via the selected AP, AP1 102-1, for example. Through the TEAP exchange process involving TEAP exchanges between the client 104 and the authentication server 108, a secure tunnel and a security association can be established for the client 104. Regardless of the configured security, to use the new mechanisms provided herein, consider that the client 104 and an AP selected for connectivity, such as AP1 102-1, both support Tunneled EAP. A Security Association (SA) in 802.11 is a set of shared security attributes, cryptographic keys, and algorithms negotiated between a wireless client and an Access Point (AP), such as a pairwise transient key security association (PTKSA).

When a client, such as client 104, supports this new mechanism for obtaining security profile information advertisements from APs and determining AKMPs and cipher suite(s) (levels of security) supported by APs, the client 104 can begin authentication with the authentication server 108 via a selected AP, such as AP1 102-1, through Tunneled EAP (TEAP) protocol exchanges for establishing a secure tunnel and a security association with the authentication server 108, as shown at reference numeral 130, for example. Recall, the authentication server 108 can be implemented as a standalone AAA node/element, can be configured for one or more APs (that is, an authentication server or service can be provided by one or more APs), and/or can be configured for the wireless network controller and can be characterized as an authentication services plane or authentication plane that facilitates authenticator or authentication services for authenticating one or more client connections with APs.

For Post-Quantum Cryptography (PQC) use cases/implementations, Post-Quantum Transport Layer Security (PQ-TLS) Security may be added to ensure that the secure tunnel created is PQC resistant. For passphrase-based use cases, Transport Layer Security Pre-Shared Key (TLS-PSK) can be used to set up a secure TEAP tunnel between the authentication server 108 and the client 104. In at least one embodiment, establishing the secure tunnel with an authentication server, such as authentication server 108, can include exchanging a digital certificate with the authentication server.

During the TEAP exchange process 130, the client 104 can signal what cipher suites the client 104 supports through one or more Client Hello messages (e.g., carried via wireless Authentication frame(s)) such that the authentication server 108 (e.g., AAA, AP, etc.) can automatically adjust to use the highest (or configured) level of security, as well as the authentication mechanism the client 104 would like to use. In at least one embodiment, the client 104 can also indicate (e.g., carried via wireless Authentication frame(s)) only one cipher suite or a small set of cipher suites that provides a desired security level, and that may be higher than the minimum security level advertised by the AP. TEAP’s flexibility in allowing different credential information, such as passphrases, client certificates (e.g., an 802.1X certificate, a digital certificate, or the like), or other EAP methods, as well as its ability to carry out credential provisioning across a secure tunnel for establishing a security association for a client device, such as client 104, can thus be effectively leveraged to have multi-security coexistence, as well as per-device credentialing. For example, for a secure tunnel established in accordance with embodiments herein, a client, such as client 104, can exchange credential information, such as a passphrase, an 802.1X certificate, a digital certificate, or the like with the authentication server 108 for authentication of the client 104 and establishment of a security association for the client 104.

While PQC resistant wireless security authentication can coexist with other IEEE 802.1X solutions within the same AKMP, CNSA requirements may necessitate an AKMP specific to its use to maintain compliance. In at least one instance, embodiments herein may facilitate reduced AKM bloat for PQC associations such that for each AKM/AKMP advertised, an AP can indicate different levels of security supported using a bitmap.

Any security credential exchange that happens beyond the TEAP exchange for network authorization and access will thus be protected. The security credentials can be IEEE 802.1X-based, or passphrase-based, and multiple different mechanisms can also be utilized within the same SSID.

With the approach as provided by embodiments herein, the plane of access and authentication, usually controlled via Service Set Identifier (SSID) Security Selection, is moved beyond the wireless plane – to the authenticator plane (e.g., AAA, AP, WLC). This allows the wireless security policy to be aligned with the network security policy, instead of the current piecemeal approach in which there can be a lack of synchronization. The plane of control will now exist at the termination point of EAP or authenticator (e.g., authentication server 108), allowing for cryptographic (crypto) agility and better coordination of cryptographic protocols. This will, in turn, enable a more cohesive security policy to be applied by network administrators, across the wireless and wired networks, whether the plane lies at the AAA, WLC, AP, or any authentication service/node.

Embodiments herein can also be extended to include aspects associated with IEEE 802.11bi, to ensure that wireless authentication may not occur over the air (OTA) but rather that the process is encrypted and secure via the secure tunnel. This would mean that the TEAP exchange and following authentication mechanism/process would occur at wireless authentication using Authentication frames rather than after wireless Association. In such an embodiment, the TEAP protocol exchanges may be carried as part of the Authentication frames during 802.11bi authentication exchanges. For example, in at least one embodiment in an IEEE 802.11bi implementation, establishing a security association for a wireless client device, such as client 104, can include transmitting wireless authentication frames including tunneled authentication protocol message information and establishing, by the wireless client device, a wireless association with an access point following establishment of the security association. In at least one embodiment, for an implementation that does not involve IEEE 802.11bi, a wireless client device, such as client 104, can establish a wireless association with an AP in which a security association for the wireless client device is established via the wireless association.

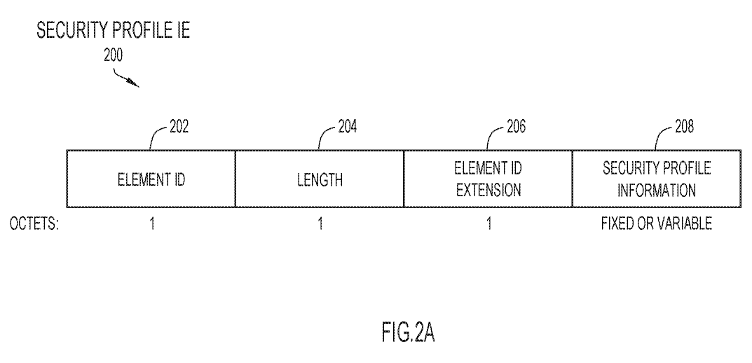

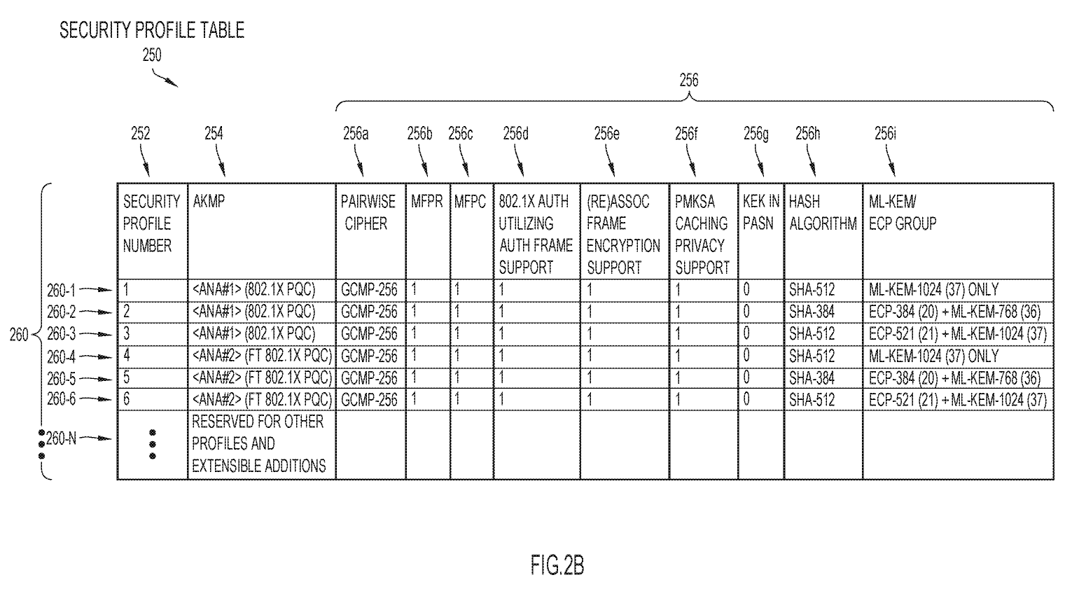

Referring to FIG. 2A, FIG. 2A depicts a security profile information element (IE) 200 that can be utilized by a WLAN AP to advertise security capabilities of the WLAN AP, according to an example embodiment.

The security profile IE 200 can be used to advertise any security capabilities, such as security profiles, supported by a WLAN AP (e.g., AP1 102-1, AP2 102-2, and AP3 103-3 of FIG. 1) using any of the AKM Only Approach, the AKM + Cipher Suite Approach, or the Bitmap/List Approach for a given SSID, as discussed for embodiments herein.

The security profile IE 200 can include an element identifier (ID) field 202 (one octet), a length field 204 (one octet), an element ID extension field 206 (one octet), and a security profile information field 208. The security profile information field 208 can be a fixed or variable number of octets, with the octet count equaling Length-1, for example. In at least one embodiment, if fewer bits are received in the security profile information field 208 than defined, the rest of the field bits may be assumed to be zero, indicating that the SSID lacks support for any other authentication processes.

The security profile information field 208 can be utilized to advertise security profiles supported by a given WLAN AP for any of the Approaches discussed herein. Before discussing the various security profile advertisement Approaches, consider FIG. 2B, which is a security profile table 250 depicting example details for various security profiles/capabilities that can be advertised by a WLAN AP, according to various example embodiments. The security profile table 250 can include any number of columns and rows through which any security capability information can be configured or defined for any number of security profiles.

A number of security profiles, each of which can be assigned a unique security profile number (e.g., 1, 2, 3, etc.), as shown at a column 252, can be defined for each of a number of rows, shown at reference numerals 260-1, 260-2, 260-3, 260-4, 260-5, 260-6 through 260-N (for any 'N' number of security profiles that may be defined), collectively referred to as rows 260, in which the number of rows (N) can depend on the number of security profiles that may be defined. A security profile number can also be referred to herein as a security profile index number.

As shown at column 254, each security profile (defined across each row) can be configured to correspond to a corresponding AKMP, as identified for the column labeled 254, and cipher suite information for each corresponding AKMP, as identified for columns 256a, 256b, 256c, 256d, 256e, 256f, 256g, 256h, and 256i, collectively referred to as columns 256. In at least one embodiment, AKMPs, as defined for column 254, can be defined using a numbering system, such as "00-0F- … XX"; for example, AKMP-24 may be defined using a numbering such as "00-0F-0C-AC-24."

In at least one embodiment, each AKMP (identified in column 254) for each security profile (each of 260-1 through 260-N) can be identified using an assigned numbers authority (ANA) number that can be defined by a standards organization, such as IEEE. For example, an identifier for <ANA#1> can identify the 802.1X PQC method of access and an identifier for <ANA#2> can identify the Fast Transition (FT) 802.1X PQC method of access.

In at least one embodiment, cipher suite information that may be configured/defined for each security profile can include pairwise cipher/group cipher information (e.g., Galois/Counter Mode Protocol (GCMP)-256) as shown at column 256a, a management frame protection required (MFPR) indication as shown at column 256b (e.g., set to '1' to indicate that MFPR is required or set to '0' to indicate that MFPR is not required), a management frame protection capable (MFPC) indication as shown at column 256c (e.g., set to '1' to indicate that MFPC is supported/enabled/provided or set to '0' to indicate that MFPC is not supported/not enabled/not provided), an 802.1X Authentication (Auth) utilizing Authentication Frame Support indication as shown at column 256d (e.g., set to '1' to indicate support or '0' to indicate no support), an association/reassociation (denoted (Re)Assoc) Frame Encryption Support indication as shown at column 256e (e.g., set to '1' to indicate support or '0' to indicate no support), a Pairwise Master Key Security Association (PMKSA) Caching Privacy Support indication as shown at 256f (e.g., set to '1' to indicate support or '0' to indicate no support), a Key Encryption Key (KEK) in Pre-Association Security Negotiation (PASN) indication as shown at column 256g (e.g., set to '1' to indicate support or '0' to indicate no support), Hash Algorithm information as shown at column 256h (e.g., SHA-512, SHA-384, etc.), and ML-KEM (Module-Lattice-Based Key-Encapsulation Mechanism) / ECP Group (Elliptic Curve Cryptography Group) information as shown at column 256i.

It is to be understood that the number of columns (256) used to configure/define cipher suite information can be varied. The cipher suite information and number of columns used to configure such information, as shown at 256, is provided for illustrative purposes only and is not meant to limit the broad scope of embodiments herein. For example, in at least one embodiment, the column including ML-KEM/ECP Group information as shown at column 256i can be expanded to two columns. Further, the column order and the type of information/indication included for each column can be adjusted for any new security profiles, any other security profile tables, etc.

In at least one embodiment for the AKM Only Approach, a list of security profile numbers that may be defined for the security profile table 250 can be included in the security profile information field 208 of the security profile IE 200 in which each security profile number corresponds to a defined combination of a method of access and a minimum cipher suite supported for the method of access. For example, all ANA#1 AKMPs as shown in the security profile table indicate GCMP-256 as the pairwise cipher/group cipher with SHA-384 as the minimum supported Hash Algorithm for the set of AKMPs for ANA#1. For instance, security profile number 2 indicates SHA-384 as the minimum supported Hash Algorithm from among the set of security profiles 1, 2, and 3 belonging to ANA#1).

In at least one embodiment for the AKM Only Approach, a list of AKMPs alone (e.g., as shown for column 254) can be included in the security profile information field 208 of the security profile IE 200 (potentially in combination with each security profile number) or can be advertised as standalone, as usual within the AKM section of the RSN, however with no cipher suite information advertised.

In at least one embodiment for the AKM + Cipher Suite Approach, a list of AKMPs (e.g., as shown for column 254) can be included in the security profile information field 208 of the security profile IE 200 to indicate methods of access (e.g., 802.1X PQC, FT 802.1X PQC, passphrase, OWE, etc.). In the AKM + Cipher Suite Approach, the cipher suite supported for each method of access can be advertised using standard RSN or some other signaling. In various embodiments, the additional cipher suite advertisement can indicate the minimum cipher suite supported for each method of access or the minimum and maximum cipher suite supported for each method of access.

In at least one embodiment for the Bitmap/Lists Approach, a bitmap with each bit corresponding to each security profile number can be included in the security profile information field 208 of the security profile IE 200. In at least one embodiment for the Bitmap/Lists Approach, a list of AKMPs can be identified and a bitmap of cipher suite information for each AKMP/method of access can be included in the security profile information field 208 of the security profile IE 200. In at least one embodiment, a list of AKMPs might be advertised with multiple bitmaps being included for each corresponding AKMP, indicating different combinations of cipher suite information supported for each AKMP/method of access. In at least one embodiment, a list of supported cipher suites might be expressed as a minimum supported cipher suite plus a bitmap for higher cipher suites. That is, the meaning of individual bits can vary according to the minimum supported cipher suite. In at least one embodiment of the Lists approach, the security profile index number is included in a security element alone or in a list (i.e., within the security profile information field 208) to indicate the different security variations supported within the WLAN.

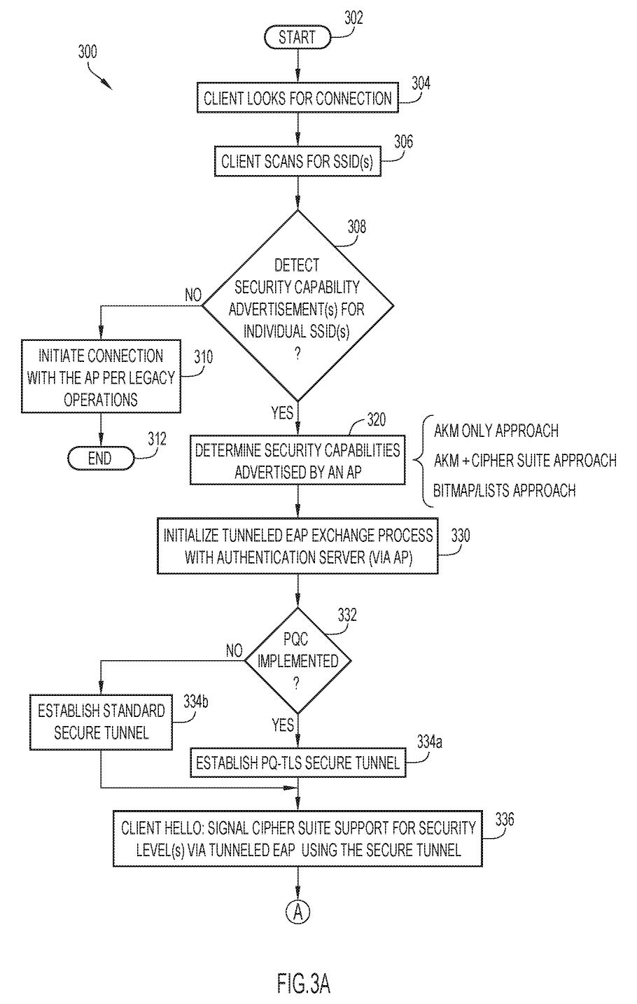

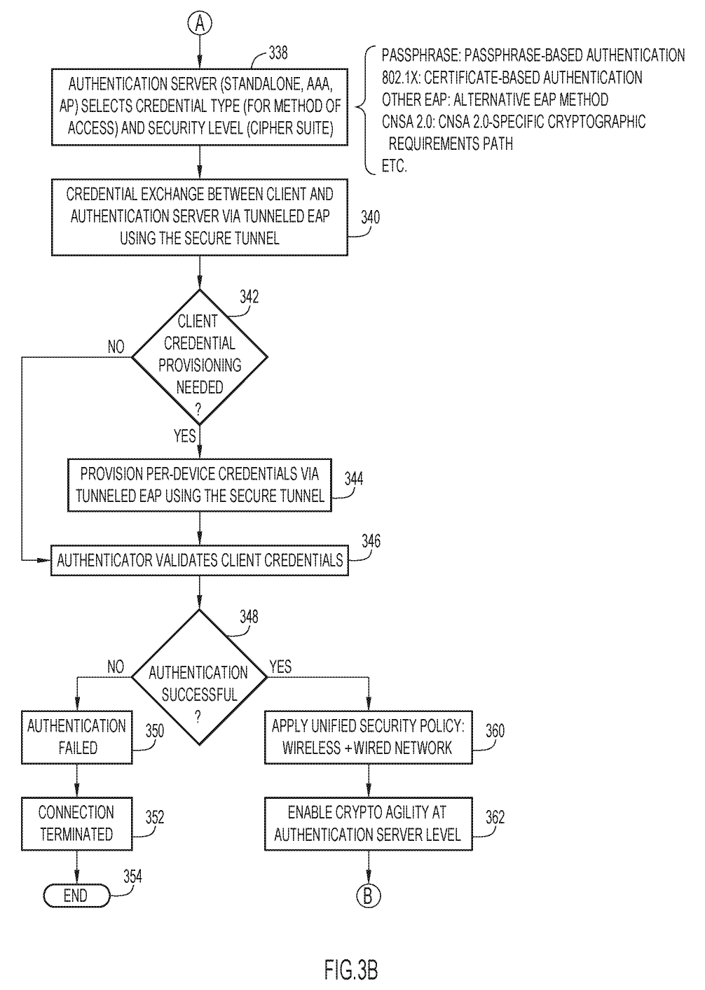

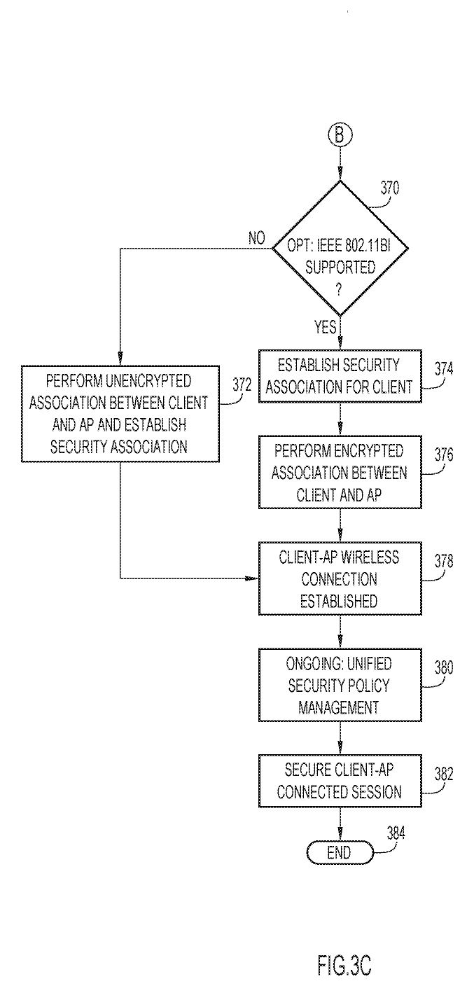

Moving to FIGS. 3A, 3B, and 3C, FIGS. 3A–3C are a flowchart 300 depicting example operations through which a tunneled EAP exchange process can be performed between a client and an authentication server (e.g., between client 104 and authentication server 108), according to various example embodiments.

Broadly, flowchart 300 illustrates an example flow involving procedures that may be utilized to facilitate a tunneled EAP exchange process, for example, to enable a client device, such as client 104, to establish a secure tunnel and a security association with an authentication server, such as authentication server 108, through wireless communications facilitated by an AP that the client has selected for wireless connection, such as AP1 102-1. The example flow further illustrates authentication exchanges that can be performed between the client 104 and an authentication server, such as authentication server 108, to negotiate cipher suite capabilities, perform a credential exchange, establish a security association, and obtain network access under a unified security policy. Flowchart 300 may begin at a start step, as shown at 302. As shown at 304, the process may include the client 104 looking for a connection. As shown at 306, the client 104 may perform radio frequency (RF)/wireless scans for one or more service set identifiers (SSIDs) being advertised by an AP, such as AP1 102-1.

As shown at 308, the process may include a determination by the client 104 regarding whether one or more security capability advertisements for individual SSID(s) are detected. In at least one embodiment, such security capability advertisements may be received by the client 104 from one or more APs, such as AP1 102-1 for the present example. If no security capability advertisement is detected (NO at 308), the process may proceed, as shown at 310, to initiate a connection with the AP per legacy operations, and the process may end, as shown at 312. However, if one or more security capability advertisements are detected by the client (YES at 308), the process may proceed to step 320.

As shown at 320, the process may include determining security capabilities advertised by an AP. In at least one embodiment, the security capabilities determined at step 320 may be obtained using any of the approaches discussed herein, such as the AKM Only Approach, the AKM + Cipher Suite Approach, or the Bitmap/Lists Approach. As shown at 330, the process may include the client 104 selecting AP1 102-1 for wireless connection and initializing a Tunneled EAP (TEAP) exchange process with the authentication service 108 via the AP1 102-1. The AP1 102-1 can assume the role of an "authenticator" for the TEAP exchange process by passing messages between the client 104 and the authentication service.

As shown at decision step 332, the process may include a determination of whether Post-Quantum Cryptography (PQC) may be implemented. If PQC is not implemented (NO at 332), the process may include the client 104 and AP1 102-1 establishing a standard secure tunnel, as shown at 334b. In at least one embodiment, for passphrase-based use cases, Transport Layer Security Pre-Shared Key (TLS-PSK) may be used to establish the standard secure tunnel. However, if PQC is implemented (YES at 332), the process may include establishing a Post-Quantum Transport Layer Security (PQ-TLS) secure tunnel between the client 104 and the authentication server 108, as shown at 334a. In at least one embodiment, establishment of the secure tunnel can include the client 104 exchanging a digital certificate with the authentication server.

Following establishment of either the standard secure tunnel or the PQ-TLS secure tunnel, the TEAP exchange process may proceed, as shown at 336, in which the client 104 may signal cipher suite support for one or more security levels to the authentication server 108 using the secure tunnel via a Client Hello message. In various embodiments, the client 104 may signal a single cipher suite, a small set of cipher suites, or a broader set of cipher suites, any of which may correspond to a security level that may be higher than a minimum security level advertised by the AP1 102-1. In at least one embodiment, the cipher suite signaling by the client 104 may include the client signaling a security profile number desired by the client alongside an AKMP (authentication mechanism/method of access) or as a standalone profile number. The process may then continue to FIG. 3B.

Continuing with FIG. 3B, as shown at 338, the authentication server 108, which may be implemented as a standalone node, an AAA server, via AP1 102-1, or via wireless network controller 106, may select a credential type corresponding to a method of access and an optimal security level (corresponding to a cipher suite to be utilized). In at least one embodiment, the credential type selected at step 338 for a given method of access may correspond to passphrase-based authentication, certificate-based authentication via IEEE 802.1X, an alternative EAP method, CNSA 2.0-specific cryptographic requirements path authentication, and/or any other credential type/method of access that may be signaled by the client 104.

As shown at 340, the process may include a credential exchange between the client 104 and the authentication server 108 via Tunneled EAP using the secure tunnel. As shown at decision step 342, the process may include a determination by the authentication server 108 regarding whether client credential provisioning may be needed for the client 104. If credential provisioning is not needed (NO at 342), the process may continue to step 346, discussed in more detail below. However, if credential provisioning is needed (YES at 342), the process may proceed to step 344. As shown at 344, the process may include provisioning per-device credentials via the tunneled EAP exchange using the secure tunnel. In one non-limiting illustrative example, credential provisioning for the client 104 at 344 can include the process of loading network credentials onto the client 104 to enable authorized access for the client 104. In at least one embodiment, credential provisioning may be performed on the basis of installing a particular certificate, on providing a username and password (e.g., for a user of the client 104), on the basis of a provided token, and/or may be performed for requestor devices on-the-fly, such as for providing guest access for a wireless client device.

Moving to 346, the process may include the authentication server 108 validating the client 104 credentials. As shown at decision step 348, the process may include a determination of whether authentication of the client 104 is successful. If authentication is not successful (NO at 348), the process may proceed, as shown at 350, to an authentication failed step, as shown at 350, and the connection can be terminated, as shown at 352, and the process may end, as shown at 354.

However, if the authentication is successfully completed (YES at 348), the process may proceed to step 360. As shown at 360, the process may include applying a unified security policy across wireless (WLAN) and wired network accesses involving the client 104. Since the client is communicating directly to the authentication server 108, the authentication server 108 is acting as an arbiter of truth and security. The authentication server 108 is aware of the security policy negotiated between itself and the client 104, such that the authentication server 108 can enforce the same through the wired infrastructure (e.g., for network 110 and/or any other wired networks). If the wired infrastructure security is lower or non-compliant, or vice versa (e.g., wireless is weaker), the authentication server 108 could inform the management plane and/or the client 104 of such discrepancies. This could be done based on user context (credentials, location, etc.) or on explicit enablement.

As shown at 362, the process may include enabling cryptographic agility at the authentication server level. In at least one embodiment, the authentication server 108, whether implemented as an AAA server, a wireless network controller 106, or an AP such as AP1 102-1, may dynamically adjust cryptographic protocols based on the cipher suite capabilities signaled by the client 104 during the Client Hello at step 336, thereby aligning the wireless security policy with the broader network (wired) security policies. The process may then continue to FIG. 3C.

Continuing to FIG. 3C, as shown at 370, it can be determined (e.g., by client 104) whether IEEE 802.11bi is supported by the AP1 102-1. For example, column 256e indicates whether or not (Re)Association Frame Support is supported, that is, whether or not 802.11bi is supported by a given AP.

Based on a determination that IEEE 802.11bi is not supported (NO at 370), the process can continue to 372, through which the client 104 and the AP1 102-1 can perform an unencrypted Association process, through which a security association is established for client 104 (via authentication server 108). The process can continue to 378, at which the client-AP wireless connection is considered to be established. For example, in at least one embodiment, for an instance in which IEEE 802.11bi is not supported by a given AP, a wireless client device, such as client 104, can establish a wireless association with the AP in which a security association for the wireless client device is established via the wireless association, as shown at 372.

However, if IEEE 802.11bi is supported (YES at 370), the process can continue to 374, through which a security association is established for the client 104 via one or more Authentication frames exchanged between the client 104 and the authentication server 108. The process can continue to 376, through which the client 104 and the AP1 102-1 can perform an encrypted Association process following establishment of the security association for client 104. The process can then continue to 378, at which the client-AP wireless connection is considered to be established. For example, in at least one embodiment, for an instance in which IEEE 802.11bi is supported by a given AP, establishing a security association, as shown at 374, for a wireless client device, such as client 104, can include transmitting wireless authentication frames including tunneled authentication protocol message information and establishing, by the wireless client device, as shown at 376, a wireless association with an access point following establishment of the security association.

As shown at 380, the process may include ongoing unified security policy management for both wireless and wired communications involving the client 104 for a secure client-AP connected session, as shown at 382, and the process can end, as generally shown at 384.

In at least one embodiment, the operations depicted in flowchart 300 across FIGS. 3A, 3B, and 3C may collectively correspond to processes including TEAP exchange processes and authentication processes through which the plane of access and authentication may be moved from the wireless advertisement layer to the authentication plane, enabling multi-security coexistence within a single SSID, per-device credentialing, and protection of all credential exchanges within a secure tunnel established for a client.

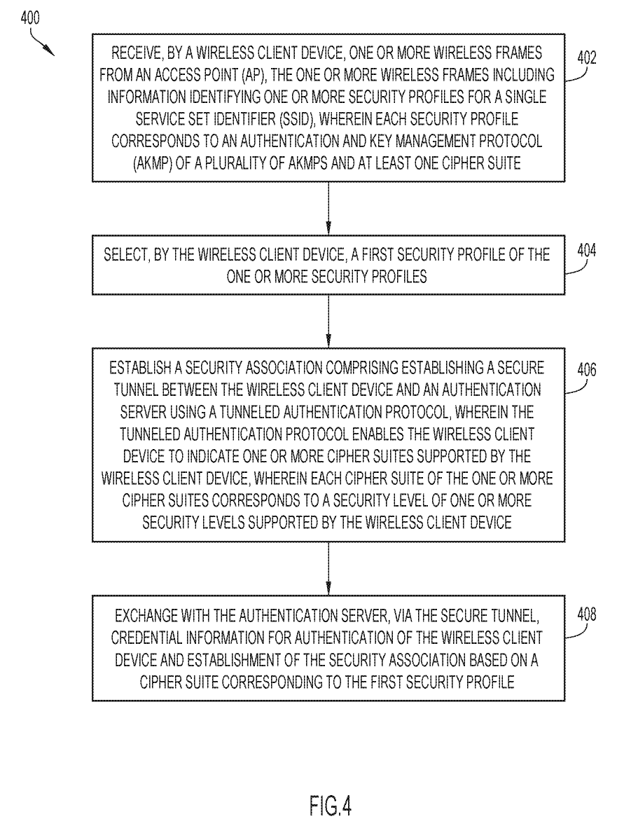

Referring to FIG. 4, FIG. 4 is a flowchart depicting a method 400 according to an example embodiment. In at least one embodiment, method 400 illustrates example operations that can be performed by a wireless client device, such as client 104, as discussed herein with reference to FIGS. 1, 2A–2B, and 3A-3C.

As shown at 402, the method may include receiving, by a wireless client device (e.g., client 104), one or more wireless frames from an access point (AP), the one or more wireless frames including information identifying one or more security profiles for a single service set identifier (SSID), wherein each security profile corresponds to an authentication and key management protocol (AKMP) of a plurality of AKMPs and at least one cipher suite. In at least one embodiment, the information identifying the one or more security profiles for the single SSID comprises a bitmap.

As shown at 404, the method may include selecting, by the wireless client device, a first security profile of the one or more security profiles.

As shown at 406, the method may include establishing a security association comprising establishing a secure tunnel between the wireless client device and an authentication server using a tunneled authentication protocol, wherein the tunneled authentication protocol enables the wireless client device to indicate one or more cipher suites supported by the wireless client device, wherein each cipher suite of the one or more cipher suites corresponds to a security level of one or more security levels supported by the wireless client device.

In at least one embodiment, the tunneled authentication protocol comprises Transport Layer Security Pre-Shared Key (TLS-PSK). In at least one embodiment, the tunneled authentication protocol comprises Post Quantum Transport Layer Security (PQ-TLS). In at least one embodiment, establishing the secure tunnel comprises exchanging a digital certificate with the authentication server.

As shown at 408, the method may include exchanging with the authentication server, via the secure tunnel, credential information for authentication of the wireless client device and establishment of the security association based on a cipher suite corresponding to the first security profile. In at least one embodiment, the credential information comprises an 802.1X certificate. In at least one embodiment, the credential information comprises a passphrase.

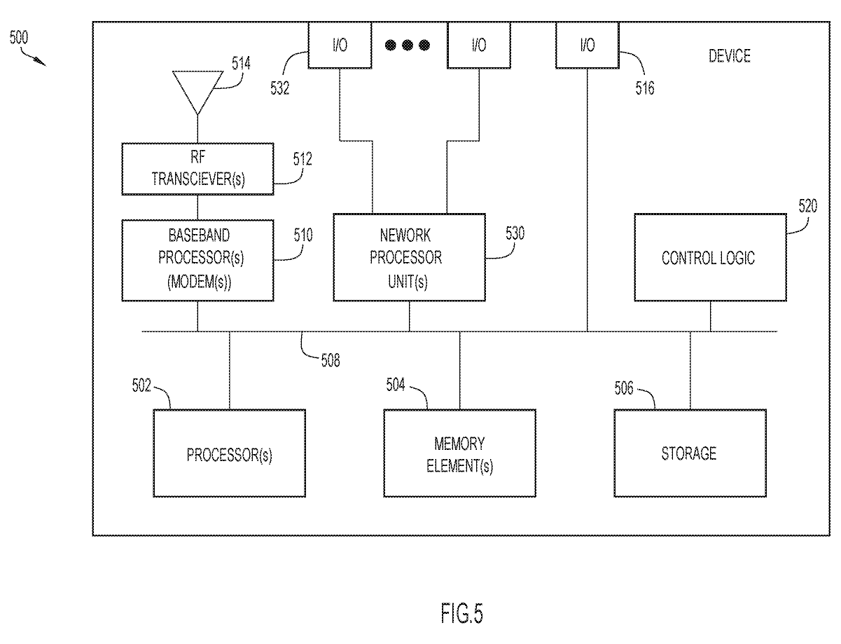

Referring to FIG. 5, FIG. 5 illustrates a hardware block diagram of a device 500 that may perform functions associated with operations discussed herein in connection with the techniques described for embodiments herein. In various embodiments, a computing device or apparatus, such as device 500 or any combination of devices 500, may be configured as any entity/entities in order to perform operations of the various techniques discussed herein. The device 500 may represent a wireless client device, an AP, an authenticator, or a wireless network controller.

In at least one embodiment, the device 500 may be any apparatus that may include one or more processor(s) 502, one or more memory element(s) 504, storage 506, a bus 508, one or more network processor unit(s) 530 interconnected with one or more network input/output (I/O) interface(s) 532, one or more I/O interface(s) 516, and control logic 520. In various embodiments, instructions associated with logic for device 500 can overlap in any manner and are not limited to the specific allocation of instructions and/or operations described herein.

Device 500 may further include at least one baseband processor or modem 510, one or more radio frequency (RF) transceiver(s) 512 (e.g., any combination of RF receiver(s) and RF transmitter(s)), and one or more antenna(s) 514 (which may be inclusive of software-defined antenna(s) or antenna array(s)) to facilitate wireless communications for the device 500 (e.g., for a wireless client device, for an AP, etc.).

In at least one embodiment, processor(s) 502 is/are at least one hardware processor configured to execute various tasks, operations, and/or functions for device 500 as described herein according to software and/or instructions configured for device 500. Processor(s) 502 (e.g., a hardware processor, such as a Central Processing Unit (CPU)) can execute any type of instructions associated with data to achieve the operations detailed herein. In one example, processor(s) 502 can transform an element or an article (e.g., data, information) from one state or thing to another state or thing. Any of the potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 504 and/or storage 506 is/are configured to store data, information, software, and/or instructions associated with device 500, and/or logic configured for memory element(s) 504 and/or storage 506. For example, any logic described herein (e.g., control logic 520) can, in various embodiments, be stored for device 500 using any combination of memory element(s) 504 and/or storage 506. Note that in some embodiments, storage 506 can be consolidated with memory element(s) 504 (or vice versa) or can overlap/exist in any other suitable manner.

In at least one embodiment, bus 508 can be configured as an interface that enables one or more elements of device 500 to communicate in order to exchange information and/or data. Bus 508 can be implemented with any architecture designed for passing control, data, and/or information between processors, memory elements/storage, peripheral devices, and/or any other hardware and/or software components that may be configured for device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 530 may enable communication between device 500 and other systems, entities, etc., via network I/O interface(s) 532 (wired and/or wireless) to facilitate operations discussed for various embodiments described herein. In various embodiments, network processor unit(s) 530 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 500 and other systems, entities, etc. to facilitate operations for various embodiments described herein. In various embodiments, network I/O interface(s) 532 can be configured as one or more Ethernet port(s), Fibre Channel ports, any other I/O port(s), and/or antenna(s)/antenna array(s) now known or hereafter developed. Thus, the network processor unit(s) 530 and/or network I/O interface(s) 532 may include suitable interfaces for receiving, transmitting, and/or otherwise communicating data and/or information in a network environment.

I/O interface(s) 516 allow for input and output of data and/or information with other entities that may be connected to device 500. For example, I/O interface(s) 516 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 512 may perform RF transmission and RF reception of wireless signals via antenna(s) 514 and the baseband processor or modem 510 performs baseband modulation and demodulation, etc. associated with such signals to enable wireless communications for device 500.

In various embodiments, control logic 520 can include instructions that, when executed, cause processor(s) 502 to perform operations, which can include, but not be limited to, providing overall control operations of a computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include a method as described herein. In one form, an apparatus as described herein is provided. In one form, a system as described herein is provided. In one form, one or more non-transitory computer-readable storage media encoded with software comprising computer-executable instructions is/are provided herein that, when executed, is/are operable to perform operations described herein.

In some aspects, the techniques described herein relate to a method including: receiving, by a wireless client device, one or more wireless frames from an access point (AP), the one or more wireless frames including information identifying one or more security profiles for a single service set identifier (SSID), wherein each security profile corresponds to an authentication and key management protocol (AKMP) of a plurality of AKMPs and at least one cipher suite; selecting, by the wireless client device, a first security profile of the one or more security profiles; establishing a security association including establishing a secure tunnel between the wireless client device and an authentication server using a tunneled authentication protocol, wherein the tunneled authentication protocol enables the wireless client device to indicate one or more cipher suites supported by the wireless client device, wherein each cipher suite of the one or more cipher suites corresponds to a security level of one or more security levels supported by the wireless client device; and exchanging with the authentication server, via the secure tunnel, credential information for authentication of the wireless client device and establishment of the security association based on a cipher suite corresponding to the first security profile.

In some aspects, the techniques described herein relate to a method, wherein the establishing the security association includes transmitting wireless authentication frames including tunneled authentication protocol message information, the method further including: establishing, by the wireless client device, a wireless association with the access point following establishment of the security association.

In some aspects, the techniques described herein relate to a method, further including establishing, by the wireless client device, a wireless association with the access point, wherein the security association is established via the wireless association.

In some aspects, the techniques described herein relate to a method, wherein the information identifying the one or more security profiles for the single SSID includes a bitmap.

In some aspects, the techniques described herein relate to a method, wherein the tunneled authentication protocol includes Transport Layer Security Pre-Shared Key (TLS-PSK).

In some aspects, the techniques described herein relate to a method, wherein the tunneled authentication protocol includes Post Quantum Transport Layer Security (PQ-TLS).

In some aspects, the techniques described herein relate to a method, wherein the credential information includes a 802.1X certificate.

In some aspects, the techniques described herein relate to a method, wherein the credential information includes a passphrase.

In some aspects, the techniques described herein relate to a method, wherein establishing the secure tunnel includes exchanging a digital certificate with the authentication server.

In some aspects, the techniques described herein relate to a wireless client device including: at least one memory element for storing data; and at least one processor for executing instructions associated with the data, wherein executing the instructions causes the wireless client device to perform operations, including: receiving, by the wireless client device, one or more wireless frames from an access point (AP), the one or more wireless frames including information identifying one or more security profiles for a single service set identifier (SSID), wherein each security profile corresponds to an authentication and key management protocol (AKMP) of a plurality of AKMPs and at least one cipher suite; selecting, by the wireless client device, a first security profile of the one or more security profiles; establishing a security association including establishing a secure tunnel between the wireless client device and an authentication server using a tunneled authentication protocol, wherein the tunneled authentication protocol enables the wireless client device to indicate one or more cipher suites supported by the wireless client device, wherein each cipher suite of the one or more cipher suites corresponds to a security level of one or more security levels supported by the wireless client device; and exchanging with the authentication server, via the secure tunnel, credential information for authentication of the wireless client device and establishment of the security association based on a cipher suite corresponding to the first security profile.

In some aspects, the techniques described herein relate to a wireless client device, wherein the establishing the security association includes transmitting wireless authentication frames including tunneled authentication protocol message information, the operations further including: establishing, by the wireless client device, a wireless association with the access point following establishment of the security association.

In some aspects, the techniques described herein relate to a wireless client device, the operations further including establishing, by the wireless client device, a wireless association with the access point, wherein the security association is established via the wireless association.

In some aspects, the techniques described herein relate to a wireless client device, wherein the information identifying the one or more security profiles for the single SSID includes a bitmap.

In some aspects, the techniques described herein relate to a wireless client device, wherein the tunneled authentication protocol includes Transport Layer Security Pre-Shared Key (TLS-PSK).

In some aspects, the techniques described herein relate to a wireless client device, wherein the tunneled authentication protocol includes Post Quantum Transport Layer Security (PQ-TLS).

In some aspects, the techniques described herein relate to a wireless client device, wherein the credential information includes a 802.1X certificate.

In some aspects, the techniques described herein relate to a wireless client device, wherein the credential information includes a passphrase.

In some aspects, the techniques described herein relate to a wireless client device, wherein establishing the secure tunnel includes exchanging a digital certificate with the authentication server.

In some aspects, the techniques described herein relate to a non-transitory computer readable storage medium including instructions that when executed configure one or more processors of a wireless client device to perform operations including: receiving, by the wireless client device, one or more wireless frames from an access point (AP), the one or more wireless frames including information identifying one or more security profiles for a single service set identifier (SSID), wherein each security profile corresponds to an authentication and key management protocol (AKMP) of a plurality of AKMPs and at least one cipher suite; selecting, by the wireless client device, a first security profile of the one or more security profiles; establishing a security association including establishing a secure tunnel between the wireless client device and an authentication server using a tunneled authentication protocol, wherein the tunneled authentication protocol enables the wireless client device to indicate one or more cipher suites supported by the wireless client device, wherein each cipher suite of the one or more cipher suites corresponds to a security level of one or more security levels supported by the wireless client device; and exchanging with the authentication server, via the secure tunnel, credential information for authentication of the wireless client device and establishment of the security association based on a cipher suite corresponding to the first security profile.

In some aspects, the techniques described herein relate to a non-transitory computer readable storage medium, wherein the establishing the security association includes transmitting wireless authentication frames including tunneled authentication protocol message information, the operations further including: establishing, by the wireless client device, a wireless association with the access point following establishment of the security association.

In some aspects, the techniques described herein relate to a non-transitory computer readable storage medium, the operations further including establishing, by the wireless client device, a wireless association with the access point, wherein the security association is established via the wireless association.

In some aspects, the techniques described herein relate to a non-transitory computer readable storage medium, wherein the information identifying the one or more security profiles for the single SSID includes a bitmap.

In some aspects, the techniques described herein relate to a non-transitory computer readable storage medium, wherein the tunneled authentication protocol includes Transport Layer Security Pre-Shared Key (TLS-PSK).

In some aspects, the techniques described herein relate to a non-transitory computer readable storage medium, wherein the tunneled authentication protocol includes Post Quantum Transport Layer Security (PQ-TLS).

In some aspects, the techniques described herein relate to a non-transitory computer readable storage medium, wherein the credential information includes a 802.1X certificate.

In some aspects, the techniques described herein relate to a non-transitory computer readable storage medium, wherein the credential information includes a passphrase.

In some aspects, the techniques described herein relate to a non-transitory computer readable storage medium, wherein establishing the secure tunnel includes exchanging a digital certificate with the authentication server.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used, such as electric, sound, light, infrared, and/or radio, to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

Communications in a network environment can be referred to herein as 'messages', 'messaging', 'signaling', 'data', 'content', 'objects', 'requests', 'queries', 'responses', 'replies', etc., which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of conventional or other databases, data stores, or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic, or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further, as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
receiving, by a wireless client device, one or more wireless frames from an access point (AP), the one or more wireless frames including information identifying one or more security profiles for a single service set identifier (SSID), wherein each security profile corresponds to an authentication and key management protocol (AKMP) of a plurality of AKMPs and at least one cipher suite;
selecting, by the wireless client device, a first security profile of the one or more security profiles;
establishing a security association comprising establishing a secure tunnel between the wireless client device and an authentication server using a tunneled authentication protocol, wherein the tunneled authentication protocol enables the wireless client device to indicate one or more cipher suites supported by the wireless client device, wherein each cipher suite of the one or more cipher suites corresponds to a security level of one or more security levels supported by the wireless client device; and
exchanging with the authentication server, via the secure tunnel, credential information for authentication of the wireless client device and establishment of the security association based on a cipher suite corresponding to the first security profile.

2. The method of claim 1, wherein the establishing the security association comprises transmitting wireless authentication frames including tunneled authentication protocol message information, the method further comprising:
establishing, by the wireless client device, a wireless association with the access point following establishment of the security association.

3. The method of claim 1, further comprising establishing, by the wireless client device, a wireless association with the access point, wherein the security association is established via the wireless association.

4. The method of claim 1, wherein the information identifying the one or more security profiles for the single SSID comprises a bitmap.

5. The method of claim 1, wherein the tunneled authentication protocol comprises Transport Layer Security Pre-Shared Key (TLS-PSK).

6. The method of claim 1, wherein the tunneled authentication protocol comprises Post Quantum Transport Layer Security (PQ-TLS).

7. The method of claim 1, wherein the credential information comprises a 802.1X certificate.

8. The method of claim 1, wherein the credential information comprises a passphrase.

9. The method of claim 1, wherein establishing the secure tunnel comprises exchanging a digital certificate with the authentication server.

10. A wireless client device comprising:
at least one memory element for storing data; and
at least one processor for executing instructions associated with the data, wherein executing the instructions causes the wireless client device to perform operations, comprising:
receiving, by the wireless client device, one or more wireless frames from an access point (AP), the one or more wireless frames including information identifying one or more security profiles for a single service set identifier (SSID), wherein each security profile corresponds to an authentication and key management protocol (AKMP) of a plurality of AKMPs and at least one cipher suite;
selecting, by the wireless client device, a first security profile of the one or more security profiles;
establishing a security association comprising establishing a secure tunnel between the wireless client device and an authentication server using a tunneled authentication protocol, wherein the tunneled authentication protocol enables the wireless client device to indicate one or more cipher suites supported by the wireless client device, wherein each cipher suite of the one or more cipher suites corresponds to a security level of one or more security levels supported by the wireless client device; and
exchanging with the authentication server, via the secure tunnel, credential information for authentication of the wireless client device and establishment of the security association based on a cipher suite corresponding to the first security profile.

11. The wireless client device of claim 10, wherein the establishing the security association comprises transmitting wireless authentication frames including tunneled authentication protocol message information, the operations further comprising:
establishing, by the wireless client device, a wireless association with the access point following establishment of the security association.

12. The wireless client device of claim 10, the operations further comprising establishing, by the wireless client device, a wireless association with the access point, wherein the security association is established via the wireless association.

13. The wireless client device of claim 10, wherein the information identifying the one or more security profiles for the single SSID comprises a bitmap.

14. The wireless client device of claim 10, wherein the tunneled authentication protocol comprises Transport Layer Security Pre-Shared Key (TLS-PSK).

15. The wireless client device of claim 10, wherein the tunneled authentication protocol comprises Post Quantum Transport Layer Security (PQ-TLS).

16. The wireless client device of claim 10, wherein the credential information comprises a 802.1X certificate.

17. The wireless client device of claim 10, wherein the credential information comprises a passphrase.

18. The wireless client device of claim 10, wherein establishing the secure tunnel comprises exchanging a digital certificate with the authentication server.

19. A non-transitory computer readable storage medium comprising instructions that when executed configure one or more processors of a wireless client device to perform operations comprising:
receiving, by the wireless client device, one or more wireless frames from an access point (AP), the one or more wireless frames including information identifying one or more security profiles for a single service set identifier (SSID), wherein each security profile corresponds to an authentication and key management protocol (AKMP) of a plurality of AKMPs and at least one cipher suite;
selecting, by the wireless client device, a first security profile of the one or more security profiles;
establishing a security association comprising establishing a secure tunnel between the wireless client device and an authentication server using a tunneled authentication protocol, wherein the tunneled authentication protocol enables the wireless client device to indicate one or more cipher suites supported by the wireless client device, wherein each cipher suite of the one or more cipher suites corresponds to a security level of one or more security levels supported by the wireless client device; and
exchanging with the authentication server, via the secure tunnel, credential information for authentication of the wireless client device and establishment of the security association based on a cipher suite corresponding to the first security profile.

20. The non-transitory computer readable storage medium of claim 19, wherein the establishing the security association comprises transmitting wireless authentication frames including tunneled authentication protocol message information, the operations further comprising:
establishing, by the wireless client device, a wireless association with the access point following establishment of the security association.

21. The non-transitory computer readable storage medium of claim 19, the operations further comprising establishing, by the wireless client device, a wireless association with the access point, wherein the security association is established via the wireless association.

22. The non-transitory computer readable storage medium of claim 19, wherein the information identifying the one or more security profiles for the single SSID comprises a bitmap.

23. The non-transitory computer readable storage medium of claim 19, wherein the tunneled authentication protocol comprises Transport Layer Security Pre-Shared Key (TLS-PSK).

24. The non-transitory computer readable storage medium of claim 19, wherein the tunneled authentication protocol comprises Post Quantum Transport Layer Security (PQ-TLS).

25. The non-transitory computer readable storage medium of claim 19, wherein the credential information comprises a 802.1X certificate.

26. The non-transitory computer readable storage medium of claim 19, wherein the credential information comprises a passphrase.

27. The non-transitory computer readable storage medium of claim 19, wherein establishing the secure tunnel comprises exchanging a digital certificate with the authentication server.
